(19) United States
(12) Patent Application Publication
(10) Pub. No.: US 2015/0158117 A1
(43) Pub. Date: Jun. 11, 2015

(54) SYSTEM AND METHOD FOR OBTAINING LAMINAE MADE OF A MATERIAL HAVING KNOWN OPTICAL TRANSPARENCY CHARACTERISTICS

(71) Applicants: David Callejo Muñoz, Milan (IT); Joseph Adam, Sacramento, CA (US); Harry Laswell, Sacramento, CA (US)

(72) Inventors: David Callejo Muñoz, Milan (IT); Joseph Adam, Sacramento, CA (US); Harry Laswell, Sacramento, CA (US)

(21) Appl. No.: 14/558,535

(22) Filed: Dec. 2, 2014

Related U.S. Application Data
(63) Continuation-in-part of application No. 14/481,667, filed on Sep. 9, 2014.
Application No. 14/481,667 is a continuation-in-part of application No. 14/481,691, filed on Sep. 9, 2014.

(30) Foreign Application Priority Data
Dec. 5, 2013 (IT) AN2013A000231
Dec. 5, 2013 (IT) AN2013A000232

(51) Int. Cl. B23K 26/00; B26F 3/06

(52) U.S. Cl. CPC B23K 26/0057; B26F 3/06

(57) ABSTRACT

A method is described for obtaining a plurality of laminae, made of a material having known optical transparency characteristics, from an ingot made of the material, the ingot having an axis of symmetry (X), the method comprising: creating, in the ingot by use of a pulsed laser beam, a plurality of sacrificial layers with modified structure, the plurality of sacrificial layers being distributed along the axis of symmetry (X), the plurality of sacrificial layers dividing the ingot in a plurality of residual layers; subjecting the plurality of sacrificial layers to chemical etching, thereby causing a separation of the residual layers; and detaching the residual layers to produce the plurality of laminae made of the material.

### PRIORITY PATENT APPLICATIONS

This is a non-provisional continuation-in-part U.S. patent application claiming priority to co-pending U.S. patent application Ser. No. 14/481,667, filed on Sep. 9, 2014 and co-pending U.S. patent application Ser. No. 14/481,691, filed on Sep. 9, 2014 with a common inventive entity. This present U.S. patent application draws priority from the referenced U.S. patent applications under 35 U.S.C §120.

The U.S. patent application Ser. No. 14/481,667, from which priority is claimed in the present application, claims priority to a co-pending Italian patent application, Serial No. AN2013A000231, filed in Italy on Dec. 5, 2013 with a common inventive entity. The U.S. patent application Ser. No. 14/481,691, from which priority is also claimed in the present application, claims priority to a co-pending Italian patent application, Serial No. AN2013A000232, filed in Italy on Dec. 5, 2013 with a common inventive entity. This present U.S. patent application also draws priority from the referenced foreign patent applications under 35 U.S.C §119. The entire disclosure of the referenced U.S. and foreign patent applications is considered part of the disclosure of the present U.S. patent application and is hereby incorporated by reference herein in its entirety.

### TECHNICAL FIELD

This patent application relates to the manufacture and processing of materials, according to one embodiment, and more specifically to a system and method for obtaining laminae made of a material having known optical transparency characteristics.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the documentation, information presentations, software, and data as described below and in the drawings that form a part of this document: Copyright 2013-2014 Espada Technology, Inc., All Rights Reserved.

### BACKGROUND

As is well known to those of ordinary skill in the art, integrated circuits, i.e., electronic components, are fabricated in an array on a wafer. The wafer is then cut, sometimes called diced, to singulate the integrated circuits from one another. However, dicing methods do not work well for use in singulating wafers from an ingot or large block of material.

In general, singulation is a material separation process that often involves the application of chemical processes and/or mechanical forces to materials, particularly brittle materials, such as strengthened glass. Other common examples of materials that are often processed to create products via singulation include, but are not limited to, amorphous solid materials, crystalline materials, semiconducting materials, a crystalline ceramics, polymers, resins, and so forth. In some cases, materials having a monocrystalline structure are used. Such materials include synthetic corundum.

Corundum is a transparent material, with chemical formula Al₂O₃, which crystallizes in the trigonal system. Corundum has a high density (around 4 g/cm3). In nature, corundum is usually coloured, due to the presence of impurities. Among the different varieties of corundum found in nature are, in particular, ruby (whose red color is due to the presence of chromium) and sapphire (whose dark blue color is due to the presence of iron and titanium). Corundum has some interesting physico-chemical properties: high hardness (second only to that of diamond), high chemical inertia, and excellent transparency.

Some methods for synthesizing corundum ingots are well known. For example, synthetic corundum can be produced in the laboratory in the form of cylindrical bars by means of melt growth techniques, such as the Czochralski method, the Kyroupolus method, or in various forms, by means of the Stephanov method.

Synthetic corundum in the form of laminae singulated from corundum ingots, because of its high breaking strength, scratch resistance, and its high chemical inertia, can be used, for example, to make transparent screens, such as screens of transparent lamination layers in which at least one of the lamination layers is composed of corundum. Corundum can therefore be used to make screens for optical sensors (destined to be exposed to aggressive external agents) and transparent protective screens for the monitors of electronic devices, such as laptop computers, smartphones, tablets, and satellite-based navigation devices.

However, the physico-chemical properties for which corundum is valued, such as hardness and chemical inertia, make its machining, particularly cutting and machining operations (such as lapping) aimed at reducing its surface roughness, complex and expensive. Traditional systems for cutting corundum laminae are based on using single wire saws or multi-wire saws with diamond impregnated metal wire. However, this technology requires long machining times, is imprecise, and is quite expensive. As an example, using these traditional techniques, it takes about 18 hours of machining to cut 200 laminae of corundum, with a cross-section of about 150 mm and a thickness of 1 mm. Because of the costs of the equipment, consumables (particularly the consumption of diamond impregnated wire), and the work time, the overall cost of cutting corundum laminae (excluding the material) is so high as to make corundum non-competitive compared with other materials such as Gorilla® glass. Additionally, cutting with diamond impregnated wire involves a waste of material, in the best cases, of at least 180-200 μm, which means that to obtain, for example, 200 one mm-thick corundum laminae, an ingot of a length of at least 240 mm is required.

Another drawback of using diamond impregnated wire to cut corundum laminae is that, in fact, it is not possible to obtain corundum laminae less than about 500 μm thick. Below this thickness threshold, the frequency of rejects drastically increases. At ambient temperature for thicknesses of more than 450-500 μm, corundum laminae have a substantially rigid behavior. This means that with the technology of cutting by means of diamond impregnated wire, it is possible to obtain only substantially rigid corundum laminae. However, the tendency of the latest generations of monitors for electronic devices, such as smartphones, is to adopt curved geometries (portions of cylindrical surfaces for example). Below the threshold of 450 μm, the corundum laminae begin gradually to have an increasingly more flexible behavior with a minimum radius of curvature inversely proportional to the thickness of the lamina. In particular, below 400 μm thick, corundum laminae start to have sufficient flexibility to enable them to be used to make monitors with a curved geometry. Consequently, it is not possible to make monitors with corundum screens, with curved geometries, by adopting the technology of cutting by means of diamond impregnated wire.

Another drawback of the technology of cutting by means of diamond impregnated wire is the fact that the laminae obtained can only be laminae with flat large surfaces parallel to each other. Cutting by use of diamond impregnated wire cannot produce cuts in a curved or three-dimensional form.

Yet another drawback of the technology of cutting by means of diamond impregnated wire is the fact that the mechanical process of cutting causes structural damage beneath the surface of the material (so-called “subsurface damage”) of a depth proportional to the particle size of the diamond dust present on the cutting wire. This thickness, indicatively 30 μm on each side of the cut sheet, must be removed before polishing the sheet. Consider also that the machining required to reduce surface roughness, in addition to requiring time, is very delicate in that it can cause irreparable damage to the corundum sheet.

With the thicknesses obtainable using the existing diamond impregnated wire cutting technology, the protective monitor screens, if made using corundum sheet-like elements, would be heavier than the monitors made using Gorilla® glass and therefore of little interest to the consumer electronics market, particularly in the case of monitors for portable devices, such as laptops and smartphones.

In some cases, lasers can be used to facilitate the singulation process. Conventional pulsed-laser machining uses the energy of the laser to ablate the material, cutting a block of the material from the outside into the interior of the block. However, this conventional laser cutting technique creates ragged cuts that make it difficult to effect the separation of a sufficiently thin lamina from a block of material.

Femtosecond lasers offer several unique advantages over lasers of longer pulse duration. In particular, the ultrashort pulse duration of femtosecond lasers makes it possible to produce extremely high target intensities with relatively low pulse energy. The high target intensities, in conjunction with ultrashort pulse duration, enable precise micron-level materials processing with minimal and/or manageable heat transfer to the target substrate per pulse. It is possible to take unique advantage of this latter property by controlling the rate of laser impact upon the target substrate. However, for optimal and practical application of the unique properties of femtosecond lasers, a laser processing system is required, which integrates and coordinates the laser operations, beam manipulation, target positioning, and processing environment. The laser processing system must also provide real-time process monitoring. This integration is very crucial to achieve the best possible processing results for a given application that uses the laser processing system.

### SUMMARY

In the various embodiments described herein, an example system and method uses a laser with an energy density that is below that which will cause ablation of the material to instead modify the structure of the material. Instead of ablating the material, an example embodiment uses a laser with an ultrashort pulse duration to modify the structure of a single-crystal material, transforming a portion of the material into a multi-crystalline or amorphous state, or a mixture of multi-crystalline and amorphous material. This modification of the structure of the material increases its chemical reactivity and decreases its mechanical strength relative to the surrounding single crystal material. For example, single-crystal corundum is almost entirely non-reactive to NaOH or KOH; but, amorphous and poly crystalline Al₂O₃ are highly reactive with these bases. The difference in reactivity is several orders of magnitude. Similarly, single-crystal corundum has very high mechanical strength compared to amorphous and poly crystalline Al₂O₃.

In the various embodiments described herein, an example method employs a two-step process. In the first step, a laser with an ultrashort pulse duration (e.g., a femtosecond or femtolaser or ultrafast laser) is used to modify the crystalline material in specific regions, thereby creating a boundary layer between portions of the material to be separated. In the second step, one of several mechanisms as described herein is used to separate the material along this boundary layer. In various embodiments, these separation mechanisms include: chemical separation, thermal separation, thermo-mechanical separation, mechanical separation, water jet separation, and secondary laser separation. The creation of the boundary layer and the various separation mechanisms are described in more detail below.

### BRIEF DESCRIPTION OF THE DRAWINGS

The various embodiments are illustrated by way of example, and not by way of limitation, in the figures of the accompanying drawings in which:

FIG. 1 is a schematic view of a corundum ingot;

FIG. 2 is a schematic view of a corundum lamina obtained from the ingot as illustrated in FIG. 1;

FIG. 3 is a schematic view of a sacrificial layer made in the ingot as illustrated in FIG. 1;

FIG. 4 is a schematic view of a laser device for creating sacrificial layers in the ingot as illustrated in FIG. 1;

FIG. 5 is a schematic view of a focal point obtained with a pulsed laser;

FIGS. 6 through 10 illustrate various examples of lenses for creation by an example embodiment;

FIGS. 11 through 16 illustrate various example three-dimensional (3D) objects for creation by an example embodiment;

FIGS. 17 through 19 illustrate other examples of lenses for creation by an example embodiment; and

FIG. 20 is a processing flow chart illustrating an example embodiment of a method as described herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method is disclosed for obtaining laminae made of a material having known optical transparency characteristics. In a particular example embodiment, the disclosure herein includes a description of a system and process for obtaining laminae, made of a material having monocrystalline structure, from an ingot made of a material having a monocrystalline structure.

For the purposes of the present description, the term “lamina” means an element having two large surfaces and a thickness of between 10 μm and 1500 μm. The term “lamina” includes elements with two large surfaces that can be flat and substantially and/or generally parallel to each other. For the purposes of the present description, the term “lamina made of crystalline material” includes crystalline materials having, on their two large surfaces which are flat and parallel to each other, the same crystallographic orientation. The term “lamina” also includes elements in which at least one of the two large surfaces is generally curved and elements in which both of the large surfaces are generally curved, even with different radii of curvature. For the purposes of the present description, the term “material having monocrystalline structure” includes synthetic corundum. The term “material having monocrystalline structure” also includes a material from the group consisting of: corundum, sapphire, diamond, ruby, quartz, silicon, silicon carbide, carborundum, fluorite, copper, germanium, gallium nitride, gallium arsenide, indium phosphide, padparadscha, tungsten, molybdenum oxide, and pure, doped and codoped (Nd, Er, Er—Yb, Cr, Nd—Cr . . . ) yttrium aluminum garnet (YAG). For the purposes of the present description, the term “ingot” includes bodies having an axis of symmetry and a cross-section that, at least in one section, is substantially and/or generally constant.

In the various embodiments described herein, a system and method is disclosed for resolving the problems of the prior art and, in particular, the problems mentioned above.

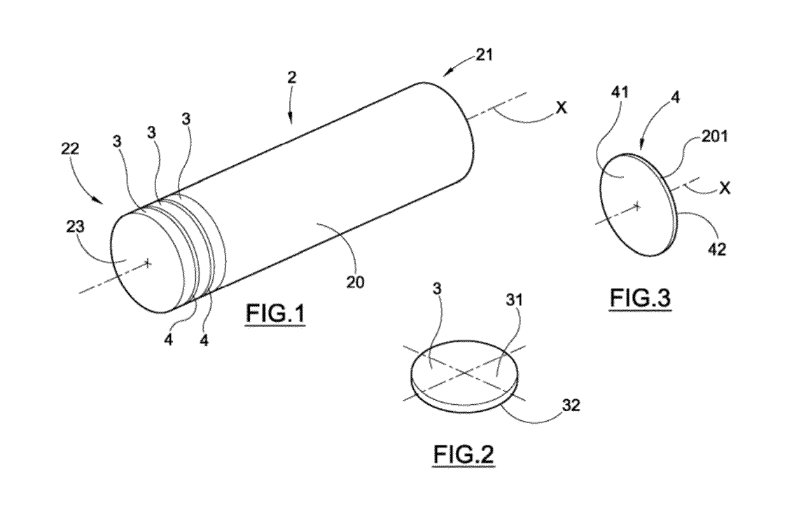

An example embodiment of a system and method for obtaining laminae from a material having known optical transparency characteristics is described with reference to the accompanying drawings. Referring now to FIG. 1, an example embodiment of the disclosed method can be used for obtaining a plurality of laminae 3, 3, . . . 3 made of a material having a monocrystalline structure, such as corundum. The plurality of laminae 3, 3, . . . 3 is obtained from an ingot 2 made of monocrystalline material having an axis of symmetry X, a lateral surface 20, which develops around the axis of symmetry X of the ingot 2, a first distal end 21, and a second distal end 22 (crossed by the axis of symmetry X). In the embodiment illustrated, the ingot 2 has a substantially and/or generally straight axis of symmetry X and a cross-section that, at least in one section, is substantially and/or generally constant. In an example embodiment of the method, the ingot 2 is a bar of monocrystalline corundum, for example a bar of corundum with a circular or rectangular cross-section obtained by means of the Czochralski process, or any other known process for producing synthetic corundum. At least one distal end 22 of the ingot 2 can have a surface 23 that is substantially flat and/or generally orthogonal to the axis of symmetry X of the ingot 2. The flat surface 23 can be obtained, for example, by cutting, with a diamond impregnated wire, a distal end of a corundum bar 2 obtained using the Czochralski method or other known method for producing synthetic corundum.

To obtain a plurality of laminae 3 from the ingot 2, the example embodiment disclosed herein provides a step of creating a plurality of sacrificial layers 4, 4, . . . 4 that develop in a manner substantially and/or generally orthogonally to the axis of symmetry X of the ingot 2. By virtue of the modification of the structure of the crystalline material of ingot 2 as effected by exposure to a laser with an ultrashort pulse duration as described in more detail below, the sacrificial layers 4, 4, . . . 4 have a modified thermal expansion coefficient and a modified chemical reactivity compared to that of the original monocrystalline material. The sacrificial layers 4, 4, . . . 4 can be distributed along the axis of symmetry (X) of the ingot 2 so as to define a plurality of intermediate layers 3, 3, . . . 3, with an unchanged thermal coefficient or chemical reactivity, interspersed with the sacrificial layers 4, 4, . . . 4. The distance between the successive sacrificial layers 4 determines the thickness of the intermediate layers 3 and, therefore, the thickness of the laminae that is desired. The form of each intermediate layer 3 is conjugated to the forms of each pair of sacrificial layers 4 between which the intermediate layer 3 is located.

In the example embodiment illustrated in FIG. 3, each sacrificial layer 4 is delimited by two flat surfaces 41, 42 that are parallel to each other and orthogonal to the axis X of the ingot 2, and by a portion 201 of the lateral surface 20 of the ingot 2, located between the intersections of the two flat surfaces 41, 42 with the lateral surface 20.

In a particular example embodiment, a separation method uses a thermal or heating process to separate the sacrificial layers 4, 4, . . . 4 and laminae 3, 3, . . . 3 formed by the intermediate layers interposed between the sacrificial layers. As illustrated in more detail below, the thermal process causes the breakage, sequential or contemporaneous, of the sacrificial layers 4, 4, . . . 4 and the consequent creation, sequential or contemporaneous, of a plurality of laminae 3, 3, . . . 3 made of monocrystalline material.

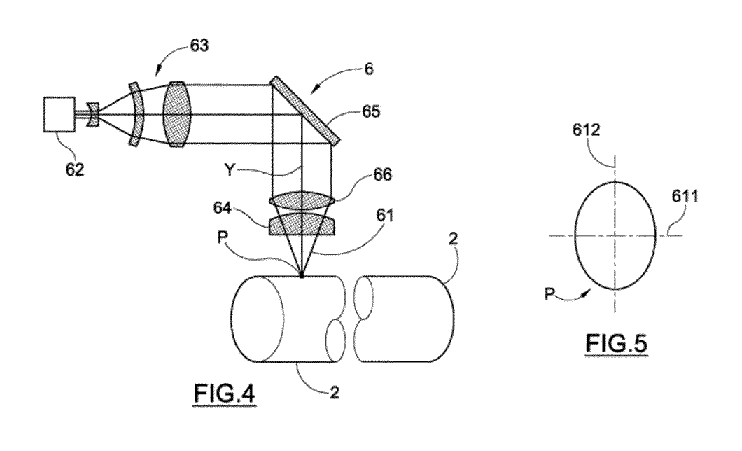

In the particular example embodiment using a thermal process, the plurality of sacrificial layers 4, 4, . . . 4, with a modified thermal expansion coefficient compared to the thermal expansion coefficient of the original monocrystalline structure, is obtained by irradiating the ingot 2 with a pulsed laser beam 61 (also known as “femtosecond laser” or “ultrafast laser”) as shown in FIG. 4. The pulsed laser creates a modification of the crystalline structure which, in turn, causes a variation of the thermal expansion coefficient inside the sacrificial layer 4. In order to create the sacrificial layer 4, the crystalline material is irradiated with a pulsed laser beam 61 (so-called “femtosecond laser” or “ultrafast laser”). For this purpose, a laser generator 6 is provided, which comprises a laser source 62, a system for transporting the laser beam 63, a focuser 64, and a system for moving the laser beam 65. The pulsed laser beam 61 has an optical axis Y on which there is a focal point P. The pulsed laser beam 61 has a sufficiently high pulse power/average power ratio to minimize the induced thermal load on the material of the ingot 2 and thus limit the transmission of heat.

At focal point P, where the light energy is concentrated, the crystalline material suffers structural damage and, consequently, a variation in the thermal expansion coefficient and chemical reactivity in the crystalline material. The high energy density, in a time on the order of femtoseconds, generates a multi-photon absorption process, able to ionize the material inside the focus area, generating micro voids on the crystal structure. Those micro voids generate an expansion wave that creates a pressure above the Young's modulus of the material, breaking the atomic bonds and generating an amorphous or poly crystalline material, without generating micro-fractures, thus modifying the thermal expansion coefficient and chemical reactivity of the crystalline material. As well known in the art, Young's modulus, also known as the tensile modulus or elastic modulus, is a measure of the stiffness of an elastic material and is a quantity used to characterize materials.

By scanning (in depth) the ingot 2 with the focal point P, a sacrificial area 4 is created (with modified crystalline structure with a consequent modified thermal expansion coefficient and chemical reactivity compared to that of the base material). The system for moving the laser beam 61 may comprise an optical movement system, with a variable-focus lens 66 and one and/or more movable mirrors 65, to alter the depth of the focal point P in the ingot 2. In order to scan the focal point P inside the ingot 2, a system of alternating linear rotation or movement of the ingot 2 (not shown) may be provided.

At the focal point P, the laser beam 61 may have an elliptical cross-section, with a small axis 611 (parallel to the axis of symmetry X of the ingot 2) and a large axis 612 (orthogonal to the axis of symmetry X of the ingot 2) as shown in FIG. 5. The size of the small axis 611 is as small as possible, so as to minimize the thickness of the sacrificial layer 4, whereas the maximum size of the large axis 612 is such as always to maintain a density of light output such as to damage the crystalline structure of the material of the ingot 2. In an example embodiment, the small axis 611 measures about 2 μm while the large axis 612 measures about 30 μm. Because the material is destined to be sacrificed, the thickness of the sacrificial layer 4 is as small as possible. In practice, the average thickness of the sacrificial layer 4 can be between 2 μm and 10 μm. In other embodiments, the thickness of the sacrificial layer 4 can be between 2 μm and 40 μm.

The interaction between the laser beam and the material of the ingot 2 is influenced by the absorption coefficient of the material which, in turn, depends on the wave length of the incident radiation. In an example embodiment of the method, the pulsed laser beam 61 used to create the sacrificial layer 4 has a wavelength λ inside or within the transparency range of the material. Preferably, the pulsed laser beam 61 has a wavelength λ of about 258 nm, 343 nm, 515 nm, 780 nm, 800 nm, or 1,030 nm. The repetition frequency f of the pulsed laser beam 61 is at least 10 kHz and, preferably, is higher than 1 MHz. The duration τ of the pulses of the laser beam 61 can be between 1×10⁻¹⁵ seconds and 1×10⁻¹⁴ seconds and, preferably, between 1×10⁻¹⁵ and 1×10⁻¹⁰ seconds. The peak energy density of the pulsed laser beam is at least 0.5 μJoules per pulse. Every material can be characterized for an energy band gap; so, the ionization process and consequently the corresponding laser parameters can be tuned for each material. Energy per pulse, pulse duration, power spatial density, laser wavelength and pulse spatial overlapping can be defined for every single material in the range of the multiphoton absorption. This set of parameters, energy per pulse, pulse duration, peak power spatial density, laser wavelength, and pulse spatial overlapping can determine when the material will suffer a phase transformation from crystalline to amorphous or poly crystalline, and when the material will suffer undesirable micro or macro fractures. We can define three regions for these parameters settings. The first region is bounded by a first parameter level threshold, below which no laser/material interaction occurs. The third region is bounded by a third parameter level threshold, above which undesirable micro or macro fractures are produced in the material. The second region, existing between the first parameter level threshold and the third parameter level threshold, corresponds to second region parameter settings that cause a desirable phase transformation in the material without causing micro or macro fractures in the material. The spatial energy density per pulse, can be determined for every different material to transfer to the material enough energy to ionize the material's structure, but not enough to fracture it. The spatial energy density per pulse for each different material depends on the energy band gap for each different material. The desired laser wavelength for each material can be chosen to be inside or within the highest optical transparency region of each different material. As a result, the femtosecond laser material ionization techniques described herein can be used on any material, given the optical transparency characteristics of the material and the second region parameter settings described above.

Because of the very short duration of the pulses of the pulsed laser beam 61 and the high surface density, there is a non-linear interaction of absorption of the photons, which causes an alteration of the properties of the irradiated material at the area of the focal point P.

In alternative embodiments of the methods described herein, multi-crystalline or polysilicon materials can also be used. The multi-crystalline or polysilicon materials can be irradiated with a femtosecond laser as described above to create the sacrificial layers 4. The use of the femtosecond laser provides several benefits over the conventional methods of applying a photoresist layer and etchant to the material. In using these conventional photoresist/etch methods on multi-crystalline or polysilicon materials, the etchant will break out of the area defined by the photoresist layer and follow the multi-crystalline boundaries beneath the etch leaving “ragged” walls in the trenches rather than straight, flat walls. The use of the femtosecond laser as described herein provides a solution to this problem. The embodiments described herein use the femtosecond laser to convert the polysilicon to amorphous silicon in the areas being removed. Then, as described in more detail below, a chemical etch, or other separation techniques described herein, can be used to remove the amorphous silicon selectively without damaging the remaining polysilicon.

Femtosecond lasers represent a source of electric field pulses, which can have field intensities approaching and even exceeding the atomic binding field. Working with a high energy confined in a very short period of time, very strong non-linear effects are generated. For an electric field of this order, the polarization response of the medium changes from linear to non-linear.

In transparent media, depending on the field intensity, the laser pulse is either non-linearly absorbed or, at lower field intensities, modifies the medium as it propagates, modulating its own spectrum. This selectivity is the main difference between the femtosecond laser interaction and the longer pulse laser interaction. This fact makes femtosecond laser systems able to manufacture intra-bulk transparent materials (e.g., structures deep inside the base material) with the highest spatial resolution and the minimum of collateral thermal damage.

Pulsed laser technology has evolved over the past four decades to the point that exawatt (10¹⁸) powers are now achievable with commercially available tabletop lasers. Tightly confining the beam to micrometer areas leads to intensities far beyond 10¹⁷ W/m². Just as the invention of the Q-switched ruby laser made accessible a new range of physical effects, the current laser technology is pushing the upper limit of the generated intensities, allowing new non-linear optical mechanisms to be measured and manufactured. The availability of high power laser sources pushed far beyond the limit of perturbative non-linear optics, beyond non-linearly ionizing electrons to relativistic non-linear optics. At 10²⁰ W/m² intensities, the electric field is capable of not only ionizing the material, but also accelerating the ionized electron to relativistic speeds all within a single pulse time duration. To reach the high peak intensities required for strong manifestation of non-linear effects, the laser pulses should be focused on areas on the order of 10 μm².

With the technology disclosed herein, we are focusing femtosecond laser pulses using high numerical aperture optical lenses. When focusing with these kinds of lenses, the laser beam is confined to a small focal area, but also to a small focal volume, reaching a very high energy density, both spatial and temporal.

In comparison with the standard long pulse lasers, short pulse laser systems are characterized in that the irradiation duration is shorter than the material energy propagation time. So, there are no thermal propagation effects inside the material, limiting the collateral damage around the working area, and allowing the working area to be limited to the focus volume. In this way, the spatial resolution increases dramatically, and the quality of the finished piece improves in parallel.

One more advantage of the short pulse laser is that the beam can be focused inside the bulk material, deep into the bulk material (e.g., several millimeters or more deep), with very low optical losses. Using a laser beam focused within the material transparency region means that the machining process can be done inside the volume of the material from outside, without interaction or damage the rest of the material where the beam is passing. Using the techniques described herein, the only laser/material interaction happens inside the focus volume, where the energy is high enough to generate non-linear absorption into the material. Longer pulse lasers will interact linearly with the material; so, the energy will be linearly absorbed by the material on the laser path through the material. As a result, no intra-bulk manufacturing can be performed with normal long pulse lasers, as for example, lasers in the pico-second range.

Femtosecond lasers have been used for micro machining and optical manufacturing on several materials, such as glass, crystals, etc. But, these prior uses of femtosecond lasers have always been for small pieces, on micro areas of the pieces, and close to the surface of the material. Femtosecond lasers have been used on structures no bigger than a few microns. These prior uses of femtosecond lasers have gone no deeper than a few tens of microns from the irradiation surface. Small piping, waveguides, and the like are the typical structures generated by the traditional use of femtosecond lasers in the micro-fluidics and micro-optics fields.

Some industrial applications of femtosecond lasers are focused on drilling, mostly metallic parts for the automotive industry; but, even in this industrial case, the holes drilled by femtosecond lasers have diameters of around 200 microns with about 200 microns in depth, thus remaining within the micro world.

With the technology described herein, we can generate macro structures, being several tens of millimetres or more in size. As such, the technology described herein can generate structures 1000 times bigger or more than the previous ones. As a result, femtosecond manufacturing is moved from the micro world, with micro-fluidics, micro-optics and micro drilling fields, to the advanced manufacturing of macro structures, such as wafers, three-dimensional (3D) pieces, and the like. Thus, the technology described herein makes an important step forward and beyond the traditional applications of femtosecond lasers.

Additionally, the technology described herein aims to work the bulk material from the inside to the outside, interacting several millimeters or more deep into the material, using the material transparency and the non-linear interaction of the femtosecond laser as described herein.

In reference to micro-fluidics, one important difference between the conventional methods and the techniques described herein is the manufacturing speeds. Typically, the traditional use of the femtosecond laser in the micro world uses less than 1 mm per second for the scanning speed. Using the techniques described herein, we can achieve scanning speeds of several hundreds of millimeters per second.

The application of a set of optimized laser wavelength, pulse duration, and delivered spatial energy density parameters to achieve a successful phase transformation is highly dependent on consistent control of delivered energy within an integrated optical path and sample movement system. The system, as described herein, can be configured to move the laser beam through the use of galvo scanners, multi-axis linear drive systems for the optical delivery structure, or combinations of these systems with multi-axis motion systems to move the materials being irradiated. The system control processes must coordinate precise and consistent focal size, pulse-to-pulse overlap, and energy delivery to achieve consistent phase transformation in the desired pattern.

Traditionally, for micro world applications, usual Gaussian laser beams are used. A Gaussian beam is a light beam where the beam intensity follows a Gaussian distribution, centered and symmetrically distributed. This kind of beam is useful for maintaining the machining symmetry, as well as to understand the laser/material interaction.

In the case of machining 3D pieces, this kind of beam, with a typical dimension of 5 to 10 microns in diameter, allows generation of small pieces with a high spatial resolution, shaped corners, and straight lines. These small pieces can be machined very precisely, depending only on the beam diameter. So, for many 3D applications, the use of Gaussian beams can be beneficial.

In the case of linear cuts, it could be better to have a beam shape maximizing the cut speed in one direction and minimizing the kerf losses from the other side (or perpendicular sides). A defocused beam with an elliptical shape can be used for this purpose. A defocused beam with an elliptical shape can be generated using a long focal distance lens. Long focal distance f-theta lenses, typical for use in laser marking scanners, can achieve a good focal distance, thereby introducing a very long optical field with a linear distance where the beam can be considered almost focused. These kinds of optics allow a very high linear scanning speed and limit the losses coming from linear interaction and thermal processes.

Bessel beams have a cylindrical shape, which have a limited kerf perpendicular to the cutting direction, but allow a deep cut parallel to the cut direction. So, low kerf and fast scanning speeds can be generated by using this type of beam shape. To generate a Bessel beam, a spatial light modulator (SLM) can be used to deform the wave front, generating a phase delay on the central part of the beam. In this way, the beam front acts like a cylinder from the point of view of the laser/material interaction. Using a Bessel beam with a 10 micron diameter and a 20 micron height can speed up the scanning process by a factor of 10 in comparison with traditional Gaussian beams for some applications.

### Chemical Separation

In a particular example embodiment, in order to achieve the detachment of the laminae 3, 3, . . . 3, the sacrificial layers 4, 4, . . . 4 can be removed by means of chemical etching. Chemical etching may be done in a particular example embodiment using hydrofluoric acid (HF), at a concentration by volume higher than 50%, at boiling temperature (about 150° C.), or a mixture of 50% by volume of sulphuric acid (H₂SO₄) and phosphoric acid (H₃PO₄), at boiling temperature (200° C. or above). The specific chemical agents, processing temperatures, pressures, and times will vary depending on what crystalline material is being processed.

In an example embodiment of the process, the ingot is arranged on a grid, for example, a grid made of polytetrafluoroethylene (PTFE), that holds the laminae 3, 3, . . . 3 after dissolving the sacrificial layers 4, 4, . . . 4. Using this method, it is possible to obtain corundum laminae 3 with a minimum thickness of 10 nm with large surfaces 31, 32 of various conformations, in particular large surfaces 31, 32 that are flat and parallel to each other. In other embodiments, corundum laminae 3 with a minimum thickness of 5 nm can be produced or thicknesses up to 5 mm.

As described herein for a particular example embodiment, chemical separation relies on the increased chemical reactivity of the modified material compared to the unmodified material. Chemical separation takes advantage of the difference in chemical reactivity between the unmodified and modified material as produced by exposure of the material to the femtosecond laser as described above. For example, in the use of the systems and methods disclosed herein in a wafering application, a block of processed material can be immersed into a tank of a chemical agent or mixtures of multiple chemical agents to chemically remove the modified material. This results in the block being converted into a number of laminae of the material, where the quantity is dependent on the size of the block, the thickness of the modified layers, and the thickness of the unmodified layers. In other applications of the systems and methods disclosed herein, a disk of material can be converted into a simple convex lens by separating the disk of material into three separate pieces, the lens and two pieces of scrap material. In still other applications of the systems and methods disclosed herein, a block of material can be converted into a three-dimensional shape by separating the block of material into multiple separate pieces, the desired three-dimensional shape and multiple pieces of scrap material.

### Thermal Separation

According to an example embodiment of the methods described herein, the breakage of the sacrificial layers 4, 4, . . . 4 occurs by creating a spatial temperature gradient along the axis of symmetry of the ingot 2. For this purpose as shown in FIG. 1, a distal end 22 of the ingot 2 is heated so as to generate a temperature gradient along the axis X which passes through the sacrificial layers 4, 4, . . . 4 in succession causing the breakage, in succession, of the sacrificial layers and thus the creation of the laminae 3, 3, . . . 3. By causing a sufficiently high spatial thermal gradient, the stresses inside the sacrificial layer 4 reach sufficiently high values to exceed the breaking stresses, causing the fracture of the sacrificial layer 4. In a particular embodiment, the spatial thermal gradient can have a value of at least 100° C./mm. The distal end 22 of the ingot 2 is heated to a temperature in the range between 600° C. and 1,300° C., for example by means of an electric heating element or by a CO₂ laser. Heating can occur, for example, by irradiation using an electrically-heated metal plate, or by exposure to an infrared laser, such as a CO₂ laser.

During heating of the distal end 22, the sacrificial layer 4 closest to the distal end 22 is stressed in compression by the intermediate layer 3, which is at a higher temperature, and is stressed in traction by the intermediate layer 3, which is at a lower temperature. This causes a breakage of the ingot 2, due to thermal load, at the sacrificial layer.

In an example embodiment of the method described herein, the laminae made of monocrystalline material 3, 3, . . . 3 are detached sequentially from the distal end 22. According to an alternative embodiment of the method, the breakage of the sacrificial layers occurs by creating a uniform temporal temperature gradient inside the ingot 2, until a contemporaneous breaking of the sacrificial layers 4, 4, . . . 4 occurs. In this alternative embodiment of the method, the ingot 2 is heated to a temperature in the range between 600° C. and 1,300° C. and the temporal thermal gradient must be at least 1° C./minute. The thermal gradient, spatial or temporal, passes through the sacrificial layer 4, (in which the thermal expansion coefficient has been modified), and the areas adjacent to the sacrificial layer 4 (in which the thermal expansion coefficient has remained unchanged).

By means of the various embodiments of the methods described herein, it is possible to obtain corundum laminae 3 with a minimum thickness of 10 μm. It is therefore possible to obtain corundum laminae of a thickness suitable to make transparent screens with a flat or curved geometry that are scratch resistant and have a higher breaking strength than that of state-of-the-art screens (such as Gorilla® glass). The lamina 3 thus obtained has no subsurface damage and has lower roughness which is a function of the small diameter 611 of the laser beam, in practice the surface roughness is less than 10 μm.

The thermal separation techniques described above take advantage of the difference in the coefficient of thermal expansion between the unmodified material and the modified material to exert physical force through expansion to separate the material. As described above, a temperature gradient is created along the axis of symmetry of the ingot 2. This temperature gradient can be a temporal temperature gradient created over time (e.g., temp cycling the material), a spatial temperature gradient created over space (e.g., one end of a block cold and one end hot), or a thermal impulse applied with another laser step to one end of the ingot 2 to “pop off” a layer, for example. It will be apparent to those of ordinary skill in the art in view of the disclosure herein that a variety of other techniques can be used to create a temperature gradient to cause separation of the material between the unmodified material and the modified material.

### Thermo-Mechanical Separation

In a variation of the example embodiment described above, a thermo-mechanical process can be used to cause separation of the material between the unmodified material and the modified material. In this example embodiment, rather than creating all of the modified portions in the material block using the laser at one time, and then chemically or thermally separating the block into a plurality of laminae, a thermo-mechanical process can be used to process one lamina at a time. In this embodiment, the laser is used, as described above, to modify a portion of the material block thereby creating a boundary layer defining one lamina. Then, a hot vacuum chuck can be attached to a surface of the unmodified material of the material block, thereby causing the surface to heat up to a pre-defined temperature. When the pre-defined temperature is reached, a mechanical force can be exerted using the vacuum chuck to pop off the lamina. The vacuum chuck can then transport the separated lamina to a delivery area while the material block is indexed and the laser process is repeated. The next boundary layer is created in the material block using the laser followed by a second hot vacuum chuck operation. This process can be repeated until the material block is fully processed and a plurality of laminae are produced therefrom.

In a variation of the thermo-mechanical process described above, the material block can be processed by the laser in a single step. In this embodiment, a plurality of boundary layers can be created in the material block to define a corresponding plurality of laminae. Then, the processed material block can be processed with the hot vacuum chuck in a second process step. In the second step, the hot vacuum chuck can be attached to a portion of the material block, thereby causing the portion to heat up to a pre-defined temperature. When the pre-defined temperature is reached, a mechanical force can be exerted using the vacuum chuck to pop off each of the plurality of laminae one at a time. This variation of the thermo-mechanical process would decouple the laser processing time from the separation processing time as the timing associated with the process steps may be substantially different.

The thermo-mechanical process as described herein is not limited to just creating laminae from a material block. In other embodiments, the thermo-mechanical process can be used, for example, to create a lens from a disk of material or other arbitrary shapes from an initial piece of material. The thermo-mechanical process can be used if there is a surface to which a vacuum chuck can be attached to enable the material to be held tightly enough.

### Mechanical Separation

In another variation of the example embodiment described above, a purely mechanical process can be used to cause separation of the material between the unmodified material and the modified material. In this example embodiment, the process is similar to the thermo-mechanical process described above, except the vacuum chuck is used with no heat. If enough damage or modification of the material at the boundary layer is caused by the laser, the vacuum chuck can be used to remove the lamina from the block without the application of heat. For example, if the material in the modified layer is converted to a fully amorphous powder, a purely mechanical process can be used.

### Water-Jet Separation

In another variation of the example embodiment described above, a water-jet separation process can be used to cause separation of the material between the unmodified material and the modified material. In this example embodiment, the process takes advantage of the fact that the modified material is not as strong as the unmodified material. As described above, a femtosecond laser can be used to create the modified material in a block of material at the boundary layers. The block of material with the modified material can then be transferred to a water jet machine. The water jet machine can be controlled or programmed to follow the path defined by the boundary layers either programmatically or by using machine vision to recognize the visual difference between the modified material at the boundary layers and the unmodified material of the remainder of the material block. Because the modified material is softer than the unmodified material as a result of the action of the femtosecond laser, the water jet can remove the modified material thereby separating the lamina from the material block without damaging the lamina.

In various example embodiments, the water jet can use pure water or water with one or more additives. In one example embodiment, water with an abrasive additive can be used to separate the lamina from the material block. The abrasive additive can be hard enough to remove the modified material, but not hard enough to damage the surface of the unmodified material. In another example embodiment, water with a chemical additive can be used with the water jet. Chemical additives, such as NaOH or KOH, combine the physical water jet action with chemical action.

In other embodiments, the various separation processes described herein can be used, for example, to create a lens from a disk of material or other arbitrary shapes from an initial piece of material.

### Secondary Laser Separation

In another embodiment of the separation techniques described herein, a secondary laser irradiation step can be used to separate a desired structure from a bulk block of material after the material has been irradiated with the femtosecond laser in a primary laser irradiation step as described above. In this embodiment, we first use the femtosecond laser in a primary laser irradiation step as described above to modify the material properties (in this case affecting material transparency) in specific areas on or within the bulk material. As a result of the primary laser irradiation step, the transparency of the material in the specific areas irradiated has been reduced. In the secondary laser irradiation step, the same areas of the material irradiated and modified in the primary laser irradiation step are irradiated again with a secondary laser. The second pass with the secondary laser can be at a much lower power than the first pass with the femtosecond laser. The secondary laser can be a femtosecond laser or another type of laser. Because the modified material is no longer transparent, by virtue of the primary laser irradiation step, the energy of the second laser irradiation at the specific areas of the material is all absorbed, providing localized heating of the modified material. This localized heating causes the modified material to expand and separates the unmodified material along this modified layer corresponding to the irradiated specific areas of the material. If the power level of the second laser is optimized appropriately, the material can be separated without introducing any undesired thermal effect (e.g., cracking) in the unmodified material.

### Near-Net Shape Machining of Three-Dimensional (3D) Shapes

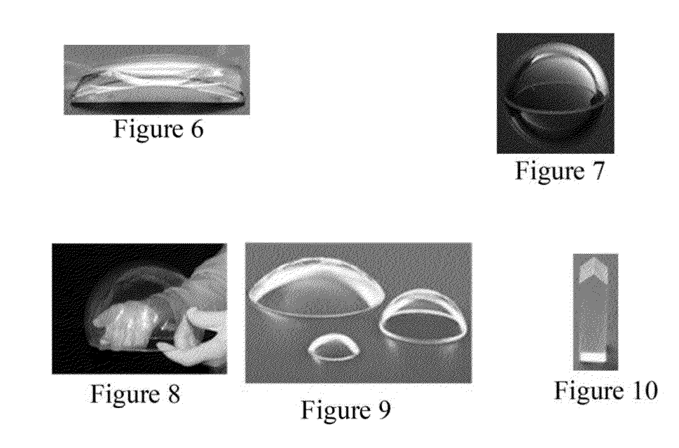

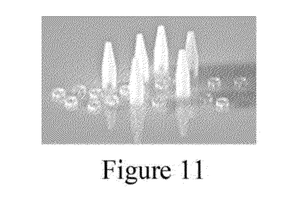

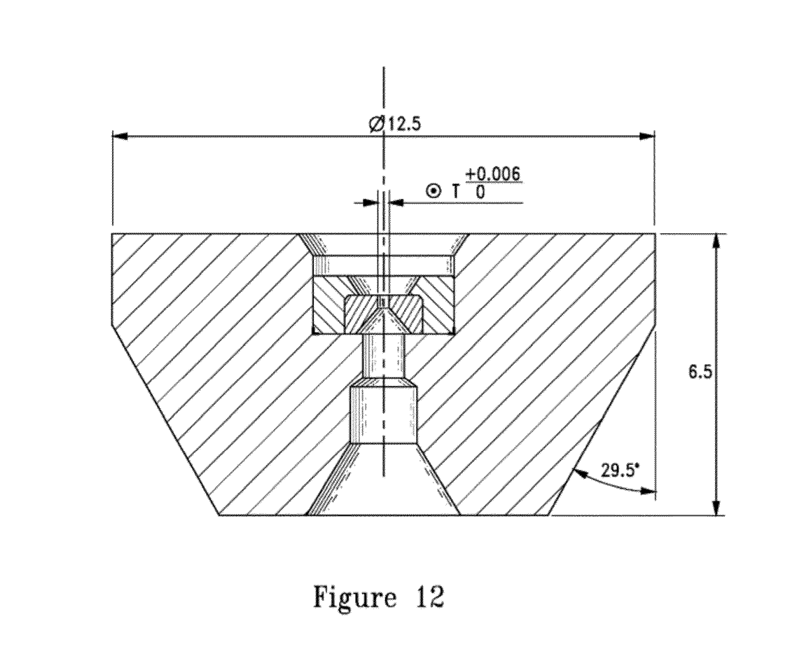

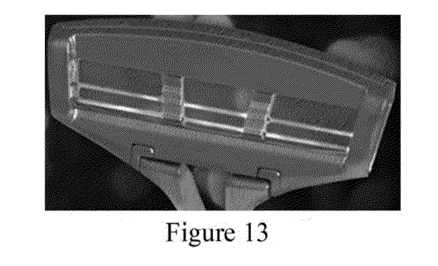

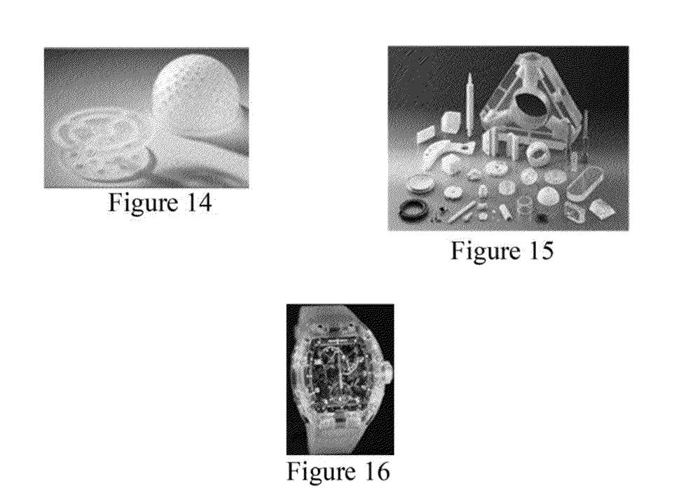

As described herein, particular example embodiments are focused on producing thin laminae or sheets of material with flat or curved surfaces that may be parallel or not from blocks of material. Various example embodiments use a cylindrical block (with a flat surface) for cutting circular laminae. In additional embodiments, the same fundamental processes as described herein can be applied to producing a myriad of simple or complex shapes. Some examples that can be manufactured from crystalline materials (e.g., sapphire, quartz, and others) using the various example embodiments described herein include:
Simple or complex convex, concave, or compound lenses, including aspherical lenses. For example, see FIG. 6.
Domes—hemispherical, or with larger or smaller included angles. For example, see FIGS. 7-9.
Prisms—For example, see FIG. 10.
Watch crystals, or even complete watch cases. For example, see FIG. 16.
Complex faceted crystals, such as those manufactured by Swarovski®, for use in decorative applications, or faceted gemstones.
Nozzles or orifices for water jet machining with complex geometries. For example, see FIGS. 11-12.
Cutting blades—such as scalpels or razor blades made from single-crystal corundum or silicon. For example, see FIG. 13.
Sapphire showerheads used in semiconductor equipment (e.g., Gavish® Brand sapphire products). For example, see FIG. 14.
Other arbitrary 3D shapes. For example, see FIG. 15.

Using previously known technologies, these shapes are typically made through a combination of sawing, machining on three axis or five axis mills, grinding, polishing, and chemical-mechanical polishing. However, as crystalline materials are brittle, and in some cases very strong (e.g., corundum), this conventional processing is very slow and expensive. In the case of corundum, conventional processing requires the use of diamond as the abrasive or cutting element, and very long processing times as corundum is almost as hard as diamond.

In contrast to the time-consuming, expensive, and imprecise technologies conventionally used, the various embodiments described herein can achieve near-net shape machining of three-dimensional (3D) shapes using a combination of three axis or five axis movement of the material block, independent movement of the laser beam delivery mechanism, and adjustment of the laser focal distance to control the location where the laser is focused inside of a block of material to submicron accuracy. The various embodiments described herein enable placement of the focal point anywhere inside the block of material. By placement of the laser focal point at any desired position on or within the block of material and with controlled movement of the material block and/or the laser beam delivery mechanism, a boundary can be traced in three-dimensions to define a desired 3D shape within the block of material. As described above, the laser modifies the material at the boundary relative to the surrounding unmodified material. As a result, the laser can be used to create regions of modified material within the block of material such that the desired two-dimensional (2D) or 3D shape is outlined by the boundary. Using any of the various separation techniques described above, the material is then separated along the modified region or boundary to expose the desired shape from the original block of material. The surface finish of the separated material is very good with less than 10 μm of variation and no sub-surface damage; so, the amount of polishing needed is substantially reduced.

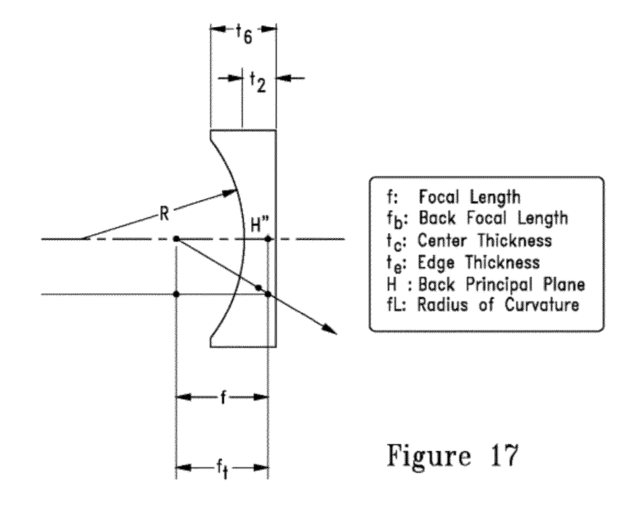

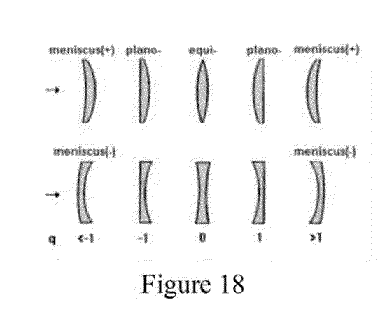

As a particular example of the process used in an example embodiment, an initial block of material can be configured as a circular disk of sapphire. Using the techniques described herein, the laser beam delivery mechanism and the position of the circular disk of sapphire can be controlled to cause the laser to trace a curved boundary layer through the circular disk of sapphire. Then, the modified disk can be separated into two pieces along the modified boundary layer. The result is a simple plano-concave lens as shown in FIG. 17. The other piece of the modified disk would be a simple plano-convex lens. Each lens can be polished after the separation to render a useful lens and an example of a 3D shape produced by the example embodiment disclosed herein. More complex lenses can be created by tracing two modified curved boundary layers within the circular disk of sapphire using the laser. This allows production of double-concave, convex, convexo-concave, or other lenses. Various example lenses produced by the example embodiments disclosed herein are illustrated in FIG. 18.

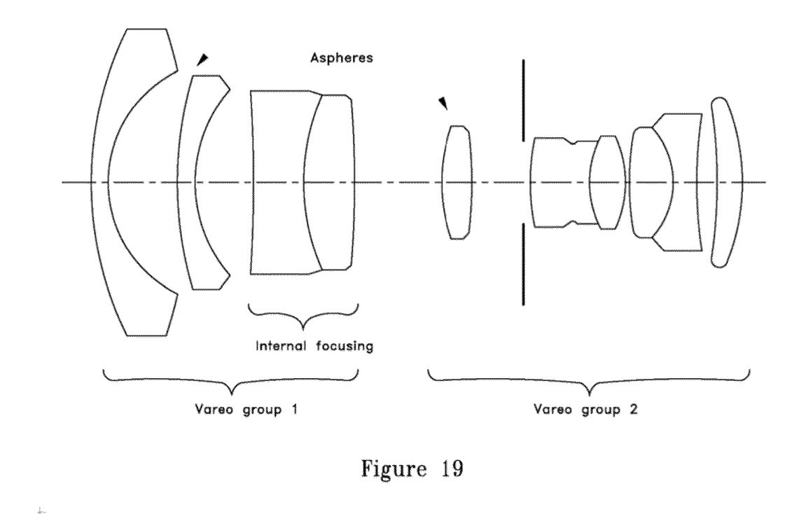

Depending on how the laser beam focal point location is programmed using the example embodiments disclosed herein, the resulting 3D shapes can be simple spherical lenses, aspherical lenses, or complex lenses, such as an eyeglass lens that includes correction for astigmatism and/or provides a progressive bifocal function. Lens elements produced using the techniques and systems described herein can be combined to make more complex lenses as shown in FIG. 19.

In various other example embodiments of the techniques disclosed herein, example embodiments can produce much more complex shapes than can be cost-effectively produced with conventional machining. For example, an embodiment can convert a cylinder of single-crystal sapphire into a sapphire champagne flute or coupe thereby creating an entirely new type of luxury good. As described above, the techniques disclosed herein can be used to trace boundary layers within the cylinder of single-crystal sapphire using the laser and then separate the sapphire champagne flute or coupe from the remaining material using the separation methods described above.

In various other example embodiments of the techniques disclosed herein, example embodiments can produce even more complex shapes. For example, FIG. 16 illustrates an example of a complete watchcase that can be produced from single-crystal sapphire. The techniques disclosed herein can be used to trace complex boundary layers within a block of single-crystal sapphire using the laser and then separate the complex 3D shape from the remaining material using the separation methods described above.

In an alternative embodiment, the femtosecond laser can be used to modify all of the material that needs to be removed, rather than just a boundary layer. As described above, the modified material produced by the femtosecond laser has different properties than the unmodified material. In particular, the modified material is less transparent, or perhaps even opaque at some wavelength(s). In a process similar to the Secondary Laser Separation process described above, a secondary laser can be used to ablate the modified material at an energy level to which the unmodified material is transparent. The secondary laser can be a femtosecond laser or a lower power picosecond or nanosecond laser. Thus, the modified material can be removed using the secondary laser and the unmodified material remains intact.

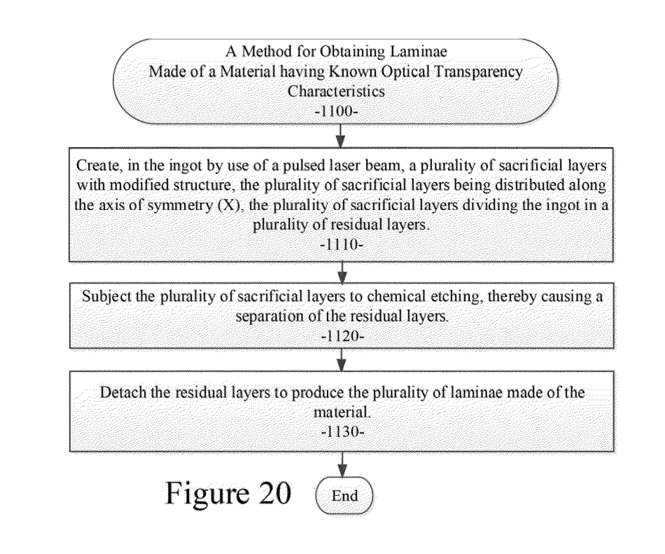

Referring now to FIG. 20, a processing flow diagram illustrates an example embodiment of a method as described herein. The method 1100 of an example embodiment for obtaining a plurality of laminae, made of a material having known optical transparency characteristics, from an ingot made of the material, the ingot having an axis of symmetry (X), the method comprising: creating, in the ingot by use of a pulsed laser beam, a plurality of sacrificial layers with modified structure, the plurality of sacrificial layers being distributed along the axis of symmetry (X), the plurality of sacrificial layers dividing the ingot in a plurality of residual layers (processing block 1110); subjecting the plurality of sacrificial layers to chemical etching, thereby causing a separation of the residual layers (processing block 1120); and detaching the residual layers to produce the plurality of laminae made of the material (processing block 1130).

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

Thus, a system and method is disclosed for obtaining laminae made of a material having known optical transparency characteristics. While the present invention has been described in terms of several example embodiments, those of ordinary skill in the art can recognize that the present invention is not limited to the embodiments described, but can be practiced with modification and alteration within the spirit and scope of the appended claims. The description herein is thus to be regarded as illustrative instead of limiting.

What is claimed is:

1. A method for obtaining a plurality of laminae, made of a material having known optical transparency characteristics, from an ingot made of the material, the ingot having an axis of symmetry (X), the method comprising:
creating, in the ingot by use of a pulsed laser beam, a plurality of sacrificial layers with modified structure, the plurality of sacrificial layers being distributed along the axis of symmetry (X), the plurality of sacrificial layers dividing the ingot in a plurality of residual layers;
subjecting the plurality of sacrificial layers to chemical etching, thereby causing a separation of the residual layers; and
detaching the residual layers to produce the plurality of laminae made of the material.

2. The method of claim 1 wherein the material has a monocrystalline structure and is from the group consisting of: corundum, sapphire, diamond, ruby, quartz, silicon, silicon carbide, carborundum, fluorite, copper, germanium, gallium nitride, gallium arsenide, indium phosphide, padparadscha, tungsten, molybdenum oxide, and yttrium aluminum garnet (YAG).

3. The method of claim 1 wherein the plurality of laminae each include at least two large generally parallel flat surfaces having a generally constant thickness and the same crystallographic orientation.

4. The method of claim 1 wherein the plurality of laminae each include at least two large curved surfaces having a generally constant thickness and the same crystallographic orientation.

5. The method of claim 1 wherein the plurality of laminae each include at least two large curved surfaces having a generally constant thickness and the same crystallographic orientation, the at least two large curved surfaces being curved in at least two dimensions.

6. The method of claim 1 wherein the plurality of laminae each include at least two non-parallel surfaces.

7. The method of claim 1 wherein the plurality of laminae each have a thickness of at least 10 μm.

8. The method of claim 1 wherein the plurality of laminae each have a roughness less than 2 μm.

9. The method of claim 1 wherein the sacrificial layers are substantially parallel to each other.

10. The method of claim 1 wherein the sacrificial layers have a modified crystalline structure with a reduced chemical inertia.

11. The method of claim 1 wherein the sacrificial layers each have a thickness no greater than 10 μm.

12. The method of claim 1 wherein the pulsed laser is a femtosecond laser producing the pulsed laser beam with a femtosecond pulse duration.

13. The method of claim 1 wherein the pulsed laser beam has a wavelength (λ) less than 1,100 nm, a repetition frequency (f) of at least 10 KHz, a pulse duration (τ) less than 1×10⁻¹² seconds, and a peak energy of at least 0.5 μJoules per pulse.

14. The method of claim 13 wherein the wavelength (λ) corresponds to one of the following values: 258, 343, 515, 780, 800, 1030 nm, and wherein the repetition frequency (f) is higher than 1 MHz, and wherein the duration (τ) of the pulses is in the range between 1×10⁻¹⁵ seconds and 1×10⁻¹² seconds.

15. The method of claim 1 including using a variable-focus lens to alter the depth of a focal point of the pulsed laser beam in the ingot.

16. The method of claim 1 including using a variable-focus lens to alter a focal point of the pulsed laser beam to produce a beam with an elliptical cross-section having a large axis orthogonal to the axis of symmetry (X) of the ingot.

17. The method of claim 1 wherein the chemical etching is performed using hydrofluoric acid (HF), at boiling temperature, or a mixture of sulfuric acid (H₂SO₄) and phosphoric acid (H₃PO₄), at boiling temperature.

18. The method of claim 1 wherein the plurality of laminae have a flat or curved geometry in a three dimensional shape.

19. The method of claim 1 including using the plurality of laminae as transparent protective screens for the monitors of electronic devices with a flat or curved geometry.

20. The method of claim 1 including generating a three-dimensional (3D) shape.

21. A method for obtaining a plurality of laminae, made of a material having known optical transparency characteristics, from an ingot made of the material, the ingot having a distal end and an axis of symmetry (X), the method comprising:
creating, in the ingot by use of a pulsed laser beam, a plurality of sacrificial layers with modified structure, the plurality of sacrificial layers being distributed along the axis of symmetry (X), the plurality of sacrificial layers dividing the ingot in a plurality of intermediate layers with an altered thermal coefficient; and
thermally causing the sequential or simultaneous breakage of the sacrificial layers to produce the plurality of laminae made of the material.

22. The method of claim 21 wherein the material has a monocrystalline structure and is from the group consisting of: corundum, sapphire, diamond, ruby, quartz, silicon, silicon carbide, carborundum, fluorite, copper, germanium, gallium nitride, gallium arsenide, indium phosphide, padparadscha, tungsten, molybdenum oxide, and yttrium aluminum garnet (YAG).

23. The method of claim 21 wherein the plurality of laminae each include at least two large generally parallel flat surfaces having a generally constant thickness and the same crystallographic orientation.

24. The method of claim 21 wherein the plurality of laminae each include at least two large curved surfaces having a generally constant thickness and the same crystallographic orientation.

25. The method of claim 21 wherein the plurality of laminae each include at least two large curved surfaces having a generally constant thickness and the same crystallographic orientation, the at least two large curved surfaces being curved in at least two dimensions.

26. The method of claim 21 wherein the plurality of laminae each include at least two non-parallel surfaces.

27. The method of claim 21 wherein the plurality of laminae each have a thickness of at least 10 μm.

28. The method of claim 21 wherein the plurality of laminae each have a roughness of less than 2 μm.

29. The method of claim 21 wherein the sacrificial layers are substantially parallel to each other.

30. The method of claim 21 wherein the sacrificial layers have a modified crystalline structure with a modified thermal expansion coefficient.

31. The method of claim 21 wherein the sacrificial layers each have a thickness no greater than 10 μm.

32. The method of claim 21 wherein the pulsed laser is a femtosecond laser producing the pulsed laser beam with a femtosecond pulse duration.

33. The method of claim 21 wherein the pulsed laser beam has a wavelength (λ) less than 1,100 nm, a repetition frequency (f) of at least 10 KHz, a pulse duration (τ) less than 1×10⁻¹² seconds, and a peak energy of at least 0.5 μJoules per pulse.

34. The method of claim 33 wherein the wavelength (λ) corresponds to one of the following values: 258, 343, 515, 780, 800, 1030 nm, and wherein the repetition frequency (f) is higher than 1 MHz, and wherein the duration (τ) of the pulses is in the range between 1×10⁻¹⁵ seconds and 1×10⁻¹² seconds.

35. The method of claim 21 including using a variable-focus lens to alter the depth of a focal point of the pulsed laser beam in the ingot.

36. The method of claim 21 including using a variable-focus lens to alter a focal point of the pulsed laser beam to produce a beam with an elliptical cross-section having a large axis orthogonal to the axis of symmetry (X) of the ingot.

37. The method of claim 21 wherein the distal end of the ingot is heated to generate a temperature gradient along the axis of symmetry (X), which crosses the plurality of sacrificial layers in a succession, the temperature gradient causing the breakage of the sacrificial layers of the ingot.

38. The method of claim 21 wherein the distal end of the ingot is heated to a temperature less than 1,300° C.

39. The method of claim 21 wherein the ingot is heated in a generally even manner to cause the simultaneous breakage of the sacrificial layers.

40. The method of claim 21 wherein the plurality of laminae are detached sequentially from the distal end using a mechanical process.

41. The method of claim 21 including using the plurality of laminae as transparent protective screens for the monitors of electronic devices with a flat or curved geometry.

42. The method of claim 21 including generating a three-dimensional (3D) shape.
